(19) United States
(12) Patent Application Publication
(10) Pub. No.: US 2025/0153048 A1
(43) Pub. Date: May 15, 2025

(54) NOTIFICATION CONTROL SYSTEM, NOTIFICATION CONTROL METHOD, AND PROGRAM

(71) Applicant: SONY INTERACTIVE ENTERTAINMENT INC., Tokyo (JP)

(72) Inventors: Kazuki NAKAMURA, Kanagawa (JP); Yasuo TAKAHASHI, Tokyo (JP)

(21) Appl. No.: 18/838,602

(22) PCT Filed: Feb. 24, 2023
(86) PCT No.: PCT/JP2023/006819

§ 371 Date: Aug. 14, 2024

(30) Foreign Application Priority Data
Mar. 10, 2022 (JP) 2022-037237

(51) Int. Cl. A63F 13/5375; G06F 3/01

(52) U.S. Cl. CPC A63F 13/5375; G06F 3/016

(57) ABSTRACT

Disclosed is an HMD (12) which provides vibration according to a preference of its user. A notification control system (10) include an acceptance section (62) that accepts setting of a vibration mode of a vibration section (42) that vibrates the HMD (12) according to a video displayed on a displaying section (38) of the HMD (12), an acquisition section (61) that acquires information relating to a recommendation degree of vibration by the vibration section (42), and a notification control section (63) that issues a notification of a vibration mode of the vibration section (42) recommended in reference to the information relating to the recommendation degree acquired by the acquisition section (61).

### TECHNICAL FIELD

The present invention relates to a notification control system, a notification control method, and a program.

### BACKGROUND ART

As disclosed in PTL 1, a head-mounted display (HMD) which presents a game video or a moving image of a movie is used. When the head-mounted display is used, then a moving image expands in front of the user's eyes, and the user can have a high feeling of presence.

### CITATION LIST

### Patent Literature

### [PTL 1]

PCT Patent Publication No. WO2015/137165

### SUMMARY

### Technical Problem

There is such a demand that a higher feeling of presence be obtained by use of a head-mounted display. To this end, it seems a promising idea to generate vibration according to a video, for example, by using a vibration motor. However, some user may prefer generation of no vibration or small vibration. If large vibration is generated for such a user as just described, then there is a possibility that the user may have an uncomfortable feeling.

The present invention has been made in view of such a situation as described above, and it is one of objects of the present invention to provide a head-mounted display that provides vibration according to a preference of its user.

### Solution to Problem

In order to solve the problem described above, a notification control system according to the present invention includes an acceptance section that accepts setting of a vibration mode of a first vibration section that vibrates a head-mounted display according to a video displayed on a displaying section of the head-mounted display, an acquisition section that acquires information relating to a recommendation degree of vibration by the first vibration section, and a notification control section that issues a notification of the vibration mode of the first vibration section recommended in reference to the information relating to the recommendation degree acquired by the acquisition section.

Further, a notification control method according to the present invention includes procedures of accepting setting of a vibration mode of a first vibration section that vibrates a head-mounted display according a video displayed on a displaying section of the head-mounted display, acquiring information relating to a recommendation degree of vibration by the first vibration section, and issuing a notification of the vibration mode of the first vibration section recommended in reference to the information relating to the recommendation degree.

Further, a program according to the present invention causes a computer to execute procedures of accepting setting of a vibration mode of a first vibration section that vibrates a head-mounted display according to a video displayed on a displaying section of the head-mounted display, acquiring information relating to a recommendation degree of vibration by the first vibration section, and issuing a notification of the vibration mode of the first vibration section recommended in reference to the information relating to the recommendation degree.

### BRIEF DESCRIPTION OF DRAWINGS

FIG. 1 is a view depicting an example of a general configuration of a notification control system according to an embodiment.

FIG. 2 is a view depicting an example of a configuration of an entertainment apparatus according to the present embodiment.

FIG. 3 is a view depicting an example of a configuration of a head-mounted display according to the present embodiment.

FIG. 4 is a functional block diagram depicting an example of functions incorporated in an analysis apparatus according to the present embodiment.

FIG. 5 is a view depicting an example of a screen image displayed at the time of start-up of a game program that provides a video to a displaying section in the present embodiment.

FIG. 6 is a view depicting an example of a screen image displayed at the time of ending of a game program that provides a video to the displaying section in the present embodiment.

FIG. 7 is a view depicting another example of a screen image displayed at the time of start-up of a game program that provides a video to the displaying section in the present embodiment.

FIG. 8 is a flow chart depicting an example of a process performed in an HMD according to the present embodiment.

### DESCRIPTION OF EMBODIMENT

In the following, an embodiment of the present invention (hereinafter referred to as the present embodiment) is described with reference to the drawings.

### [Overview of General Configuration of Notification Control System 10]

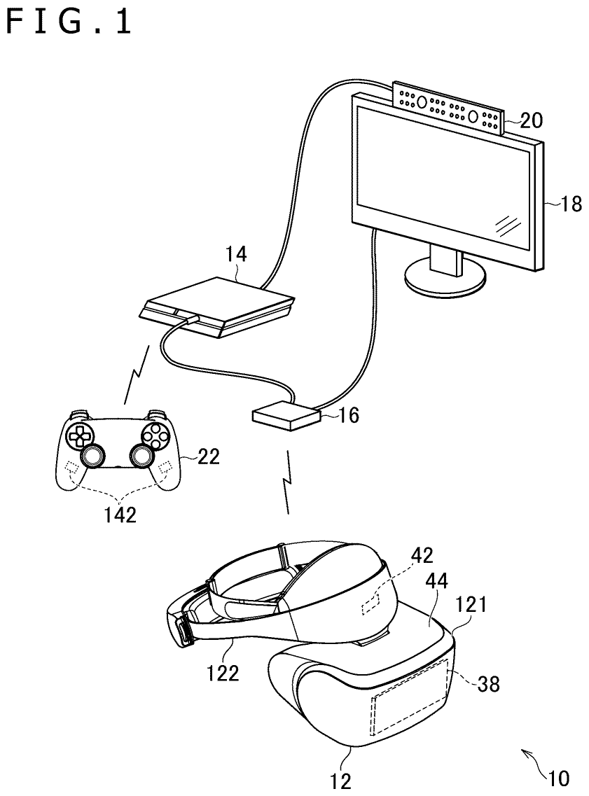

FIG. 1 is a view depicting an example of a general configuration of a notification control system according to the present embodiment. As depicted in FIG. 1, a notification control system 10 according to the present embodiment preferably includes, for example, a head-mounted display (hereinafter referred to also as an HMD) 12, an entertainment apparatus 14, a relay apparatus 16, a television set 18, a camera-microphone unit 20, and a controller 22 serving as an operation member. It is to be noted that the general configuration of the notification control system 10 depicted in FIG. 1 is exemplary and is not restrictive, and the notification control system 10 may not include, for example, the television set 18, the camera-microphone unit 20, the relay apparatus 16, and so forth.

### [Configuration of Entertainment Apparatus 14]

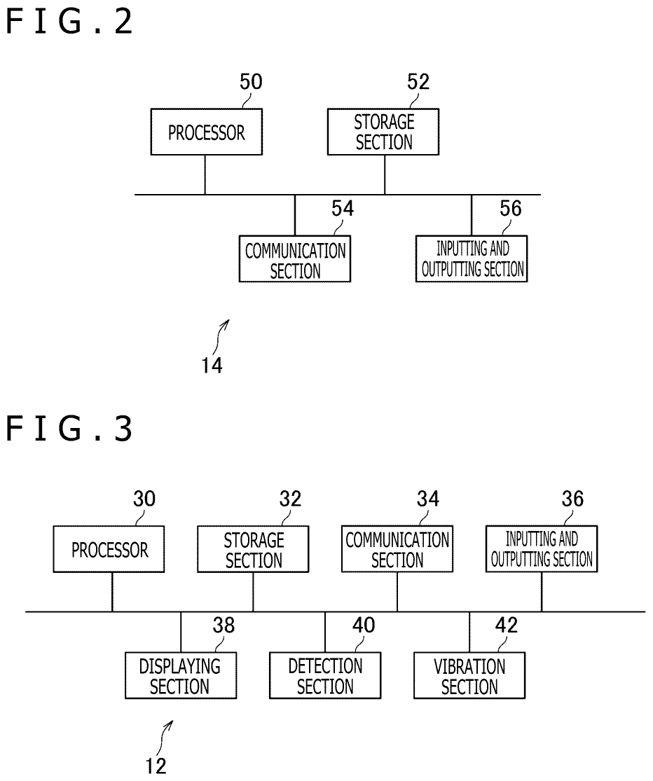

FIG. 2 is a view depicting an example of a configuration of the entertainment apparatus according to the present embodiment. The entertainment apparatus 14 according to the present embodiment preferably includes, for example, as depicted in FIG. 2, a processor 50, a storage section 52, a communication section 54, and an inputting and outputting section 56.

The entertainment apparatus 14 preferably is a computer such as a game console, a digital versatile disk (DVD) player or a Blu-ray (registered trademark) player, for example. The entertainment apparatus 14 according to the present embodiment preferably generates a video and sound, for example, by execution of a game program, reproduction of a moving image content, or the like, the game program or the moving image content being stored therein or recorded on an optical disk. Further, the entertainment apparatus 14 according to the present embodiment preferably outputs a video signal representative of a video to be generated and a sound signal representative of sound to be generated to the television set 18 and the HMD 12 through the relay apparatus 16.

The processor 50 preferably is, for example, a program-controlled device such as a central processing unit (CPU) that operates in accordance with a program installed in the entertainment apparatus 14.

The storage section 52 preferably is, for example, a storage device such as a read only memory (ROM) or a random access memory (RAM), or a hard disk drive. It is preferable that a program or the like that is executed by the processor 50 be stored in the storage section 52. The communication section 54 preferably is, for example, a communication interface such as a wireless local area network (LAN) module or the like. The inputting and outputting section 56 preferably is an input/output port such as a High-Definition Multimedia Interface (HDMI) (registered trademark) port or a universal serial bus (USB) port.

It is to be noted that the components provided in the entertainment apparatus 14 may be those incorporated in the HMD 12.

### [Configuration of HMD 12]

The HMD 12 preferably includes a main body 121 and a mounting band 122 as depicted in FIG. 1. The mounting band 122 preferably has an annular shape that surrounds the head of a user as a whole. It is to be noted that, in the present embodiment, the “user” signifies a person who wears the HMD 12.

The main body 121 preferably includes a housing 44 that accommodates a displaying section 38 and so forth therein and configures an exterior for the same. The mounting band 122 is preferably connected to an upper portion of the main body 121.

FIG. 3 is a view depicting an example of a configuration of the head-mounted display according to the present embodiment. As depicted in FIG. 3, the HMD 12 preferably includes a processor 30, a storage section 32, a communication section 34, an inputting and outputting section 36, a displaying section 38, a detection section 40, and a vibration section 42 that is a first vibration section.

The processor 30 is preferably, for example, a program-controlled device such as a microprocessor that operates in accordance with a program installed in the HMD 12. The storage section 32 is preferably, for example, a storage device such as a ROM or a RAM. It is preferable that a program or the like to be executed by the processor 30 be stored into the storage section 32. The communication section 34 is preferably, for example, a communication interface such as a wireless LAN module. It is to be noted that, while an example in which the HMD 12 can communicate with the entertainment apparatus 14 by wireless communication is depicted in FIG. 1, a configuration by which communication can be performed by wired communication may be applied. The inputting and outputting section 36 is preferably, for example, an input/output port such as an HDMI (registered trademark) port or a USB port.

The displaying section 38 is, for example, a display such as a liquid crystal display or an organic electroluminescence (EL) display, and preferably displays a video and so forth generated by the entertainment apparatus 14. The displaying section 38 is preferably arranged in front of the eyes of the user. The displaying section 38 preferably receives, for example, a video signal outputted by the entertainment apparatus 14 and relayed by the relay apparatus 16 and outputs a video represented by the video signal.

It is preferable that the displaying section 38 be so configured as to be capable of displaying a three-dimensional image, for example, by displaying an image for the left eye and an image for the right eye. It is to be noted that the displaying section 38 may be not only a device that displays a three-dimensional image but also a device that displays only a two-dimensional image.

The detection section 40 is preferably, for example, a sensor such as an acceleration sensor or a motion sensor. The detection section 40 preferably outputs a measurement result of a posture, a rotation amount, and a moving amount of the HMD 12 to the processor 30.

The vibration section 42 is preferably, for example, a vibration device that configures an eccentric motor. The vibration section 42 is driven (vibrated) in accordance with an instruction received from the entertainment apparatus 14. As depicted in FIG. 1, the vibration section 42 is preferably provided, for example, at a front portion of the mounting band 122. It is to be noted that, in FIG. 1, arrangement of the vibration section 42 is depicted, and also a shape of the vibration section 42 is depicted schematically. It is sufficient if the vibration section 42 is provided on the HMD 12 in such a manner as to cause the HMD 12 to vibrate, and the arrangement thereof is not restricted to that depicted in FIG. 1.

The vibration section 42 is preferably vibrated, for example, when an object or a game character that is operated by the user takes some action, when it is subject to impact, or in any other similar case. The mounting band 122 vibrates in association with vibration of the vibration section 42, and the vibration is transmitted to the head of the user. Consequently, the user can enjoy an experience having a feeling of presence.

The hardware configuration of the computers described above is not restricted to the example described above, and various kinds of hardware can be applied. For example, the hardware configuration may include a reading section for reading a computer-readable information storage medium (for example, an optical disk drive or a memory card slot). For example, a program or data stored in an information storage medium may be supplied to the computer through the reading section or the inputting and outputting section.

### [Function of HMD 12]

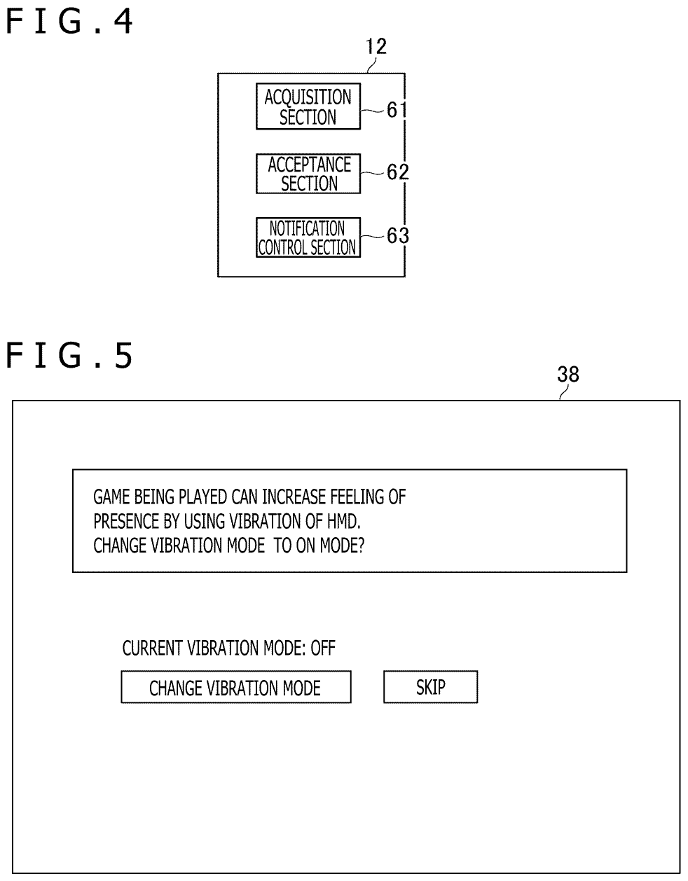

FIG. 4 is a functional block diagram depicting an example of functions incorporated in the HMD according to the present embodiment. As depicted in FIG. 4, the HMD 12 preferably includes an acquisition section 61, an acceptance section 62, and a notification control section 63. The functions are preferably incorporated mainly in the processor 30.

The acquisition section 61 acquires information relating to a recommendation degree of vibration by the vibration section 42. In the present embodiment, in a case where the recommendation degree is high, vibration of the HMD 12 is recommended to the user, but in a case where the recommendation degree is low, non-vibration of the HMD 12 is recommended to the user.

The information relating to the recommendation degree preferably includes information that is set, for example, for each game program that provides a video to be displayed on the displaying section 38 or for each moving image content that provides a video to be displayed on the displaying section 38. It is to be noted that the information relating to the recommendation degree may be set not only for each game program that provides a video to be displayed on the displaying section 38 but also for each genre of a game program that provides a video to be displayed on the displaying section 38. For example, in a case of an action game, the recommendation degree is preferably low, but in a case of a role-playing game, the recommendation degree is preferably high. Alternatively, the opposite may be true for the high and low levels of the recommendation degree. Similarly, also in regard to moving image content, information relating to a recommendation degree may be set for each genre.

The acceptance section 62 accepts setting of a vibration mode of the vibration section 42. The acceptance section 62 preferably accepts a change of the vibration mode of the vibration section 42 according to an operation input using the controller 22 by the user. Alternatively, the acceptance section 62 may accept a change of the vibration mode of the vibration section 42 in reference to information relating to a recommendation degree hereinafter described. In other words, the acceptance section 62 may be configured such that the vibration mode is automatically changed in reference to the information relating to the recommendation degree.

The vibration mode of the vibration section 42 preferably includes, for example, an ON mode in which vibration is performed and an OFF mode in which vibration is stopped. In the ON mode, the strength of vibration can be set step by step. For example, of the ON mode, in a “high mode,” vibration is preferably great, but in a “low mode,” vibration is preferably small, and in “middle mode,” vibration has the intermediate strength between those in the high mode and the low mode. Further, the vibration mode is not restricted to a mode distinguished according to the strength of vibration, and may be a mode distinguished according to a length of vibration or the like. For example, in vibration generated in the same situation, the duration of vibration in the low mode is preferably shorter than the duration of vibration in the high mode.

The notification control section 63 issues a notification of a recommended vibration mode of the vibration section 42 to the user in reference to the information relating to the recommendation degree acquired by the acquisition section 61. The notification by the notification control section 63 is preferably performed by sound or displaying. In particular, for example, the notification control section 63 preferably issues a notification of the recommended vibration mode of the vibration section 42 to the user by displaying on the displaying section 38 or the television set 18. Further, the notification control section 63 may issue a notification of the recommended vibration mode of the vibration section 42 to the user by sound through an unillustrated earphone provided on the HMD 12. In this case, for example, sound of “turning on the vibration mode of the head-mounted display is recommended” or the like is preferably outputted.

For example, since there is a possibility that some user may feel uncomfortable in a game program in which the vibration section 42 vibrates at high frequency, the recommendation degree of vibration is preferably set low. In this manner, in a case where a game program in which the recommendation degree of vibration is low is executed, the notification control section 63 preferably issues a notification of the OFF mode as a recommended vibration mode of the vibration section 42.

Meanwhile, for example, in moving image content in which the vibration section 42 vibrates only in a specific scene, vibration necessary from a viewpoint of staging is only provided, and since the possibility that the user may feel uncomfortable is low, the recommendation degree is preferably set high. In this manner, in a case where moving image content for which the recommendation degree of vibration is high is used, the notification control section 63 preferably issues a notification of the ON mode as a recommended vibration mode of the vibration section 42.

Further, the information relating to the recommendation degree may include information relating to a current vibration mode of a vibration section 142 that is a second vibration section that causes the controller 22 operated by the user of the HMD 12 to vibrate. FIG. 1 depicts an example in which the controller 22 includes vibration sections 142 that cause the controller 22 to vibrate in each of portions to be gripped by the right hand and the left hand of the user. As is the case with the vibration section 42, it is preferable that the vibration mode be changeable also for the vibration section 142. In particular, the vibration mode of the vibration section 142 preferably includes at least an ON mode in which vibration is performed and an OFF mode in which vibration is stopped.

Here, in a case where the user sets the current vibration mode of the vibration section 142 to the OFF mode, there is a possibility that the user is feeling undesirable to use the vibration function. In particular, a user who sets the vibration mode of the vibration section 142 of the controller 22 to the OFF mode is highly likely to be desiring that also the vibration mode of the vibration section 42 of the HMD 12 be set to the OFF mode. Therefore, in a case where the current vibration mode of the vibration section 142 is the OFF mode, the notification control section 63 preferably issues a notification of the OFF mode as the recommended vibration mode of the vibration section 42.

It is to be noted that the controller 22 and the vibration section 142 depicted in FIG. 1 are exemplary, and the shape of the controller 22 and the arrangement of the vibration section 142 are not restricted to those depicted in FIG. 1.

Further, the information relating to the recommendation degree may include information relating to a vibration situation in a game currently being played. For example, in a case where vibration that could cause the user to feel uncomfortable during playing of a game is performed and the user interrupts the play of the game, the notification control section 63 preferably issues a notification of the OFF mode as a recommended vibration mode of the vibration section 42. Note that, in this case, the notification control section 63 preferably issues a notification of the OFF mode as a recommended vibration mode of the vibration section 42 by sound or by displaying on the television set 18. Here, the case in which vibration that could cause the user to feel uncomfortable is performed is preferably, for example, a case in which vibration having a predetermined vibration frequency is performed continuously for a predetermined period of time or any other similar case. Further, the case in which the user interrupts the current game may be a case in which the user removes the HMD 12 from his/her own head or any other similar case. The user removing the HMD 12 from his/her own head may be determined, for example, from a detection result of the detection section 40 being inputted to the processor 30.

Further, the information relating to the recommendation degree may include information relating to a use situation in the past of the user. The information relating to a use situation in the past may be the number of times of use and a use frequency of the vibration function. For example, in a case where the vibration section 42 is in the ON mode in a game played most recently, the notification control section 63 preferably issues a notification of the ON mode as a recommended vibration mode of the vibration section 42. Further, for example, in a case where the number of times by which the vibration section 42 is set to the OFF mode is greater than the number of times by which the vibration section 42 is set to the ON mode in the 10 playing times in the past, the notification control section 63 preferably issues a notification of the OFF mode as a recommended vibration mode of the vibration section 42.

All or some of the functions provided in the HMD 12 according to the present embodiment described above may be incorporated in some other computer.

### Example of Screen Image

Examples of a screen image displayed on the displaying section 38 of the HMD 12 according to the present embodiment are described with reference to FIGS. 5 to 7.

FIG. 5 is a view depicting an example of a screen image displayed at the time of start-up of a game program that provides a video to the displaying section according to the present embodiment. FIG. 5 depicts a situation in which the current vibration mode of the vibration section 42 is the OFF mode. Further, FIG. 5 depicts a situation in which a sentence that recommends that the vibration mode of the vibration section 42 be set to the ON mode is displayed.

From a notification of such displaying as described above issued at the time of start-up of a game program, the user can select to change the vibration mode of the vibration section 42 to the ON mode. For example, the user preferably performs an inputting operation for selecting “Change vibration mode” in a screen image to change the current vibration mode to the ON mode. In particular, the acceptance section 62 preferably accepts a change of the vibration mode of the vibration section 42 in response to an inputting operation performed by the user on the controller 22. This makes it possible to start a game in a state in which the vibration section 42 can be vibrated.

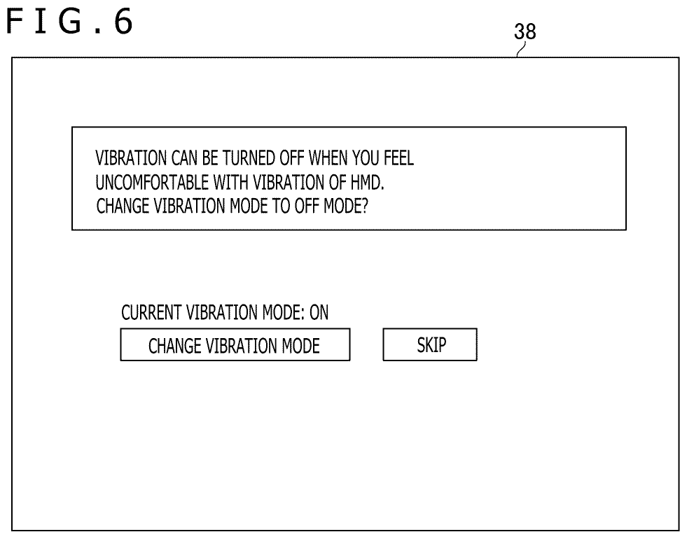

FIG. 6 is a view depicting an example of a screen image displayed at the time of ending of a game program that provides a video to the displaying section according to the present embodiment. FIG. 6 depicts a situation in which the current vibration mode of the vibration section 42 is the ON mode. Further, FIG. 6 depicts a situation in which a sentence that recommends that the vibration mode of the vibration section 42 be set to the OFF mode is displayed.

By a notification of such displaying as just described issued at the time of ending of a game program, the user can select to change the vibration mode of the vibration section 42 to the OFF mode. For example, the user preferably performs an inputting operation for selecting “Change vibration mode” in a screen image to change the current vibration mode to the OFF mode. In particular, the acceptance section 62 preferably accepts a change of the vibration mode of the vibration section 42 in response to an inputting operation performed by the user on the controller 22. Consequently, the next play can be started in a state in which vibration of the vibration section 42 is stopped.

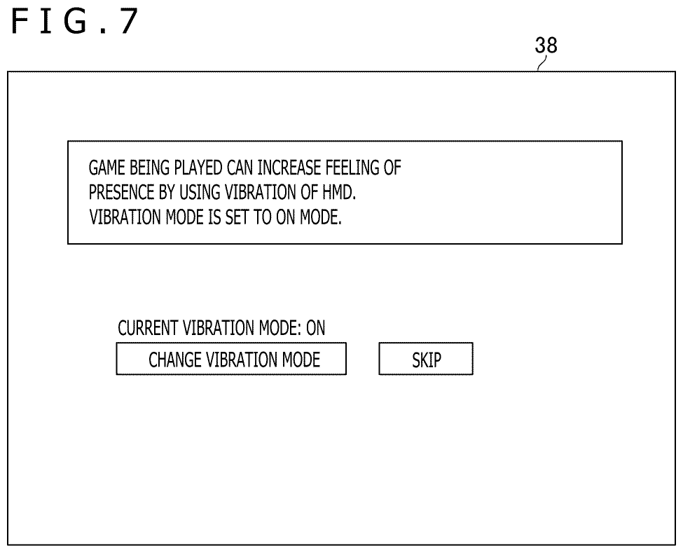

FIG. 7 is a view depicting an example of a screen image displayed at the time of start-up of a game program that provides a video to the displaying section according to the present embodiment. FIG. 7 depicts a situation in which a sentence for giving such a notification that the current vibration mode of the vibration section 42 is set to the ON mode is displayed. As depicted in FIG. 7, a notification of a recommended vibration mode may preferably be issued after the vibration mode is set automatically to a vibration mode recommended according to a recommendation degree corresponding to a game program. Also in this case, it preferable that the current vibration mode can be changed to the OFF mode by the user performing an inputting operation for selecting “Change vibration mode” in a screen image.

Note that, in FIGS. 5 to 7, in a case where the user does not want to change the vibration mode of the vibration section 42, an inputting operation for selecting “Skip” in a screen image is preferably performed. Consequently, the current vibration mode can be maintained.

Further, screen images depicted in FIGS. 5 to 7 are exemplary, and some other information not depicted may be displayed. Further, the screen images depicted in FIGS. 5 to 7 are not restricted to those displayed on the screen of the displaying section 38 of the HMD 12 and may be displayed otherwise on the screen of the television set 18. Further, the timing at which the screen images depicted in FIGS. 5 to 7 are displayed is not restricted to the time of start-up or ending of a game program and may be a timing in the middle of playing.

### [Flow Chart]

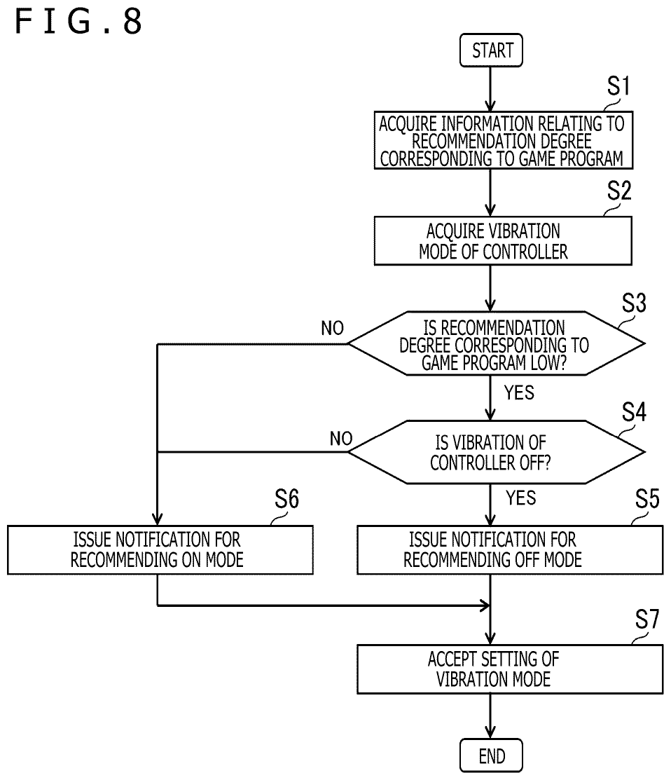

Here, an example of a flow of a process performed in the HMD 12 according to the present embodiment is described with reference to a flow chart exemplified in FIG. 8. FIG. 8 is a flow chart depicting an example of a process that is performed in the HMD according to the present embodiment. It is to be noted that, in FIG. 8, an example of a process at the time of start-up of a game program is depicted.

First, information relating to a recommendation degree corresponding to a game program to be executed is acquired by the acquisition section 61 (step S1), and a vibration mode of the vibration section 142 of the controller 22 is acquired (step S2).

In a case where the recommendation degree corresponding to the game program to be executed is low (YES in step S3) and the vibration mode of the vibration section 142 of the controller 22 is the OFF mode (YES in step S4), a notification of the OFF mode as a recommended vibration mode is issued by the notification control section 63 (step S5). It is to be noted that, in step S5, a notification of “weak mode” of the ON mode, as a recommended vibration mode, may be issued by the notification control section 63.

If at least one of a case in which the recommendation degree corresponding to the game program to be executed is high (NO in step S3) or another case in which the vibration mode of the vibration section 142 of the controller 22 is the ON mode (NO in step S4) is applicable, then a notification of the ON mode as a recommended vibration mode is issued by the notification control section 63 (step S6).

Thereafter, setting of the vibration mode of the vibration section 42 is accepted by the acceptance section 62 in response to the inputting operation performed by the user on the controller 22 (step S7).

The invention claimed is:

1: A notification control system comprising:
an acceptance section that accepts setting of a vibration mode of a first vibration section that vibrates a head-mounted display according to a video displayed on a displaying section of the head-mounted display;
an acquisition section that acquires information relating to a recommendation degree of vibration by the first vibration section; and
a notification control section that issues a notification of the vibration mode of the first vibration section recommended in reference to the information relating to the recommendation degree acquired by the acquisition section.

2: The notification control system according to claim 1, wherein
the information relating to the recommendation degree includes information set for each game program that provides the video or for each moving image content that provides the video.

3: The notification control system according to claim 1, wherein
the information relating to the recommendation degree includes information relating to a current vibration mode of a second vibration section that vibrates an operation member that is operated by a user of the head-mounted display.

4: The notification control system according to claim 1, wherein
the notification control section issues a notification of the recommended vibration mode of the first vibration section by displaying on the displaying section.

5: A notification control method comprising:
accepting setting of a vibration mode of a first vibration section that vibrates a head-mounted display according to a video displayed on a displaying section of the head-mounted display;
acquiring information relating to a recommendation degree of vibration by the first vibration section; and
issuing a notification of the vibration mode of the first vibration section recommended in reference to the information relating to the recommendation degree.

6: A program for a computer, comprising:
by an acceptance section, accepting setting of a vibration mode of a first vibration section that vibrates a head-mounted display according to a video displayed on a displaying section of the head-mounted display;
by an acquisition section, acquiring information relating to a recommendation degree of vibration by the first vibration section; and
by a notification controlling section, issuing a notification of the vibration mode of the first vibration section recommended in reference to the information relating to the recommendation degree.
